(19) United States
(12) Patent Application Publication
(10) Pub. No.: US 2004/0125866 A1
(43) Pub. Date: Jul. 1, 2004

(54) Method for determining the interference power in CDMA radio receiver, and a CDMA radio receiver

(76) Inventors: Holger Gryska, Munchen (DE); Bin Yang, Herrenberg (DE)

Correspondence Address: LERNER AND GREENBERG, P.A., POST OFFICE BOX 2480, HOLLYWOOD, FL, 33022-2480, US

(21) Appl. No.: 10/637,194

(22) Filed: Aug. 8, 2003

Related U.S. Application Data
(63) Continuation of application No. PCT/DE02/00406, filed on Feb. 4, 2002.

(30) Foreign Application Priority Data
Feb. 8, 2001 (DE) 101 05 733.4

(51) Int. Cl. H04B 1/707

(52) U.S. Cl. 375/148

(57) ABSTRACT

In a method for determining the interference power in a CDMA radio receiver, once a received signal has been despread, the interference power of the despread signal is determined by comparing received symbols with symbols that are known a-priori to the receiver and with received and determined data symbols that are not known a-priori to the receiver.

### CROSS-REFERENCE TO RELATED APPLICATION

This application is a continuation of copending International Application No. PCT/DE02/00406, filed Feb. 4, 2002, which designated the United States and was not published in English.

### BACKGROUND OF THE INVENTION

Field of the Invention

The invention relates to a method for determining the interference power in a CDMA (Code Division Multiple Access) radio receiver, and to a CDMA radio receiver having a device for determining the interference power.

Third-generation mobile radio networks, UMTS (Universal Mobile Telecommunications System), are based on the W-CDMA (Wideband-Code Division Multiple Access) modulation method. In W-CDMA, all of the channels or subscriber signals to be transmitted can use the entire available frequency range. Code-division multiplexing is used to separate the various channels, as required for multiple access. In this case, each channel (to be more precise: each symbol in a channel) has a channel-specific orthogonal code sequence modulated onto it. By using the channel-specific orthogonal code sequence, the receiver can separate the desired channel (or each individual symbol in this channel) from the totality of all of the transmitted channels. In figurative terms, the code sequence represents a fingerprint, which is applied to each symbol and makes it possible to distinguish this symbol from symbols in other channels.

The individual channels interfere with one another, since the characteristics of the spread codes that are used are not ideal. Furthermore, each channel is subject to multipath propagation, which means that, for one transmitted signal, two or more received signal versions arrive at the receiver with different power levels and with different time delays. For a CDMA system to operate at all and to allow the available frequency range to be used optimally, it is therefore of major importance for the interference power on each individual channel to ideally have the same magnitude in the receiver.

Otherwise, it is possible for a channel with a comparatively high interference power to conceal the other channels, and to make their detection impossible. For this reason, every CDMA system uses power control.

The power control for a CDMA system is based on measuring the ratio of the useful power to the interference power (SINR: Signal to Interference plus Noise Ratio) for all the detected channels in the receiver. The receiver then transmits this measured value in the form of a transmission power control command (TCP) back to the transmitter on the back channel. The transmitter then individually adapts the transmission power for each channel, in order to achieve a standard SINR for all the channels in the receiver. One advantageous side effect in this case is that this power control can compensate within certain limits for fluctuations in the physical mobile radio channel (slow fading), thus allowing the transmission capacity to be increased. It is clear that power control in a CDMA system plays a major role, with a critical influence on the overall performance of the system.

Power control per se is specified by the respective Standard. The controlled variable is the SINR, the ratio of the useful power to the interference power in a detected channel. The measurement of the useful power is relatively simple. However, it is considerably more difficult to measure the interference power, although this has a significant influence on the measurement accuracy of the SINR, since this factor is located in the denominator of the useful power to interference power ratio.

The UMTS Standard states that the interference power should be determined from the pilot symbols, which are known a-priori to the receiver, after the despreading of the received signal.

The difficulty that occurs in this case is that insufficient pilot symbols for accurate measurement of the interference power are often available in the dedicated channels. For example, in the case of UMTS, there may be only two pilot symbols in each time slot available for interference power measurement, depending on the time slot structure that is chosen. Since the interference power measurement also includes the channel estimation, which is likewise subject to a measurement error, the estimation error in the evaluation of only a small number of pilot symbols is evident in a significant reduction in the performance of the overall CDMA system.

The accuracy of the interference power determination may be improved by using as many known symbols as possible for the measurement. Furthermore, averaging methods can be used to reduce the measurement error. However, both measures have the disadvantage that they increase the control response time constant, and can thus adversely affect the capability of the system to compensate for power fluctuations during signal transmission.

### SUMMARY OF THE INVENTION

It is accordingly an object of the invention to provide a CDMA radio receiver and a high-precision method for determining the interference power in a CDMA radio receiver, which overcome the above-mentioned disadvantages of the prior art apparatus and methods of this general type. In particular, it is also an object of the invention to provide a CDMA radio receiver that is designed to measure the interference power of a despread received signal with high accuracy.

The inventive method accordingly provides for symbols, which are not known a-priori in the receiver in addition to the symbols that are known a-priori in the receiver, in the received signal to be used to determine the interference power. The detected symbols are then determined downstream from the receiver, and are fed back for the interference power measurement. Although it should be assumed that a certain proportion of the detected data symbols will be determined incorrectly, a considerable improvement in the accuracy of the determination of the interference power can be achieved nevertheless, because of the considerable increase in the number of symbols which are used for calculating the interference power.

A further advantageous aspect of the method is characterized in that the interference power is determined in the signal path downstream from the receiver. Any desired receivers may be used for this procedure. An alternative procedure, which is predicated on a RAKE receiver, is for the interference power to be determined by measuring the individual path interference powers for each RAKE finger upstream of the combiner for the RAKE receiver, and for the interference power to be determined from the individual measured path interference powers. While the first procedure (determination of the interference power downstream from the receiver) is less complex to implement, the second procedure (determination of the individual path-related interference powers) offers somewhat better accuracy.

A further improvement in the accuracy of determining the interference power can be achieved by determining the power of the symbols that are known a-priori and the power of the data symbols that are not known a-priori, and by calculating the interference power taking into account these two determined powers. In this case, power differences between the symbols that are known a-priori (pilot symbols) and the data symbols that are not known a-priori can be taken into account in the determination of the interference power. Power differences such as these, which may possibly occur in particular with multiple code procedures, are not known in the receiver and must therefore be determined by measurement.

In the situation where the symbols that are known a-priori and the symbols which are not known a-priori are the pilot symbols and the payload data symbols for a single channel, in particular the dedicated DPCH channel in accordance with the UMTS Standard, a further advantageous measure of the method is characterized in that, in addition to these symbols, further symbols from one or more further channels are used for determining the interference power. By way of example, the further channel may be the common pilot channel for the downlink path.

With the foregoing and other objects in view there is provided, in accordance with the invention, a CDMA radio receiver for receiving a signal of spread-coded symbols that are transmitted via a transmission channel. The CDMA radio receiver includes: a unit for proving a despread signal by despreading the signal that has been received; a channel estimator for determining channel parameters for the transmission channel; a receiver having an output; a data symbol decision maker connected to the output of the receiver; and a device for determining an interference power of the despread signal. The device for determining the interference power is supplied with the channel parameters determined by the channel estimator. The device for determining the interference power is supplied with data symbols determined by the data symbol decision maker. The device for determining the interference power is designed for determining the interference power of the despread signal by comparing received data symbols with symbols that are known a-priori in the receiver and data symbols that are not known a-priori in the receiver. The data symbol decision maker determines the data symbols that are not known a-priori in the receiver.

Other features which are considered as characteristic for the invention are set forth in the appended claims.

Although the invention is illustrated and described herein as embodied in a method for determining the interference power in a CDMA radio receiver, and a CDMA radio receiver, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic illustration of the UMTS channel structure for the downlink path; and

FIG. 2 is a block diagram of a baseband section of a CDMA radio receiver according to the invention.

### DESCRIPTION OF THE PREFERRED EMBODIMENTS

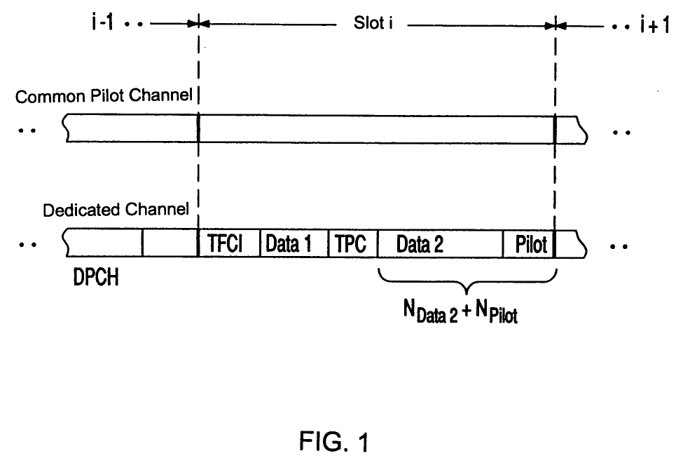

Referring now to the figures of the drawing in detail and first, particularly, to FIG. 1 thereof, there is shown a schematic illustration of the common pilot channel and of the multiplexed dedicated channel DPCH (Dedicated Physical Channel) on the downlink path. The horizontal extent corresponds to the time axis.

The dedicated channel DPCH is formed from two multiplexed dedicated channels DPDCH (Dedicated Physical Data Channel) and DPCCH (Dedicated Physical Control Channel). The DPCCH channel includes sections of pilot symbols Pilot and of control information TPC and TFCI. The DPDCH channel contains payload data, which are contained in the sections Data1 and Data2. The data structure which is shown for a time slot i is repeated in each of the preceding and subsequent time slots i−1 and i+1.

On the downlink path, UMTS uses three common physical channels, one of which (the first CCPCH (Common Control Physical Channel)) includes a common pilot channel. This common pilot channel is illustrated in FIG. 1, and is available for all mobile stations.

Pilot symbols have the characteristic feature that they are known a-priori in the receiver. To be more precise, the pilot symbols which are transmitted in the common pilot channel are known in each mobile station in the radio area of the transmitting base station, while the pilot symbols which are transmitted in the dedicated channel are known in that receiver for which they are intended in accordance with CDMA coding.

The signal-to-noise ratio SINR, which is also often referred to in the literature as the SIR, is defined by the equation

$$SINR = \frac{{P}_{RSCP}}{{P}_{ISCP}} . \qquad ( 1 )$$

P_{RSCP} (RSCP: Received Signal Code Power) in this case denotes the useful power and PISCP (ISCP: Interference Signal Code Power) denotes the interference power of the detected channel with respect to a chip.

According to a first exemplary embodiment of the invention, the interference power, related to a chip, of the detected channel PISCP is determined using the following equation:

$${P}_{ISCP} = R \cdot ( {\sum }_{k = 1}^{{N}_{Data 2}} {\vert d \cdot {r}_{k} - {P}_{a} \cdot {p}_{Data 2 , k} \vert}^{2} + {\sum }_{k = {N}_{Data 2} + 1}^{{N}_{Data 2} + {N}_{Pilot}} {\vert {r}_{k} - {P}_{a} \cdot {p}_{Pilot , k} \vert}^{2} ) \\ where R = \frac{1}{{N}_{Data 2} + {N}_{Pilot} - 1} \qquad ( 2 )$$

In this case, Nₚᵢₗₒₜ denotes the number of pilot symbols P_{Pilot,k} available in a time slot in the Pilot section, and N_{Data2} denotes the number of fed-back determined data symbols P_{Data2,k}. These may include all the data symbols contained in the Data2 section, or else only some of the data symbols contained in the Data2 section. The symbol rₖ denotes the received symbols at the receiver output, and Pₐ denotes the power of the channel impulse response determined by the channel estimation.

The variable d denotes a factor which takes account of any possible difference between the transmission power of the pilot symbols and the data symbols. Since power differences such as these are not known a-priori in the receiver, the invention provides for the variable d to be estimated using the following relationship:

$$d = \sqrt{\frac{{P}_{RSCP , Pilot}}{{P}_{RSCP , Data 2}}} \qquad ( 3 )$$

In this case, P_{RSCP,Pilot} denotes the signal power of the pilot symbols in the dedicated channel DPCH, and P_{RSCP,Data2} denotes the signal power of the data symbols from the Data2 section of the dedicated channel.

It should be noted that the accuracy of the estimate of P_{ISCP} is dependent on the one hand on the quality of the channel estimate and on the other hand is influenced by the number N_{Data2}+Nₚᵢₗₒₜ. The greater this number of symbols which are taken into account overall for determining the interference power, the better the estimation accuracy for the determination of P_{ISCP}.

A second exemplary embodiment of the inventive method relates to the determination of the interference power specifically for a RAKE receiver. As already mentioned, radio signals in mobile radio are subject to multipath propagation. That is to say, two or more received signal versions occur at the receiver due to reflection, scatter and diffraction of the transmitted radio signal on various obstructions in the propagation path, and these are shifted in time with respect to one another, and are attenuated to different extents. The principle of operation of the RAKE receiver is based on the idea of first of all evaluating two or more of these received signal versions separately, and of then superimposing them with the correct timing in order to achieve a detection gain that is as high as possible. The designation RAKE in this case provides a figurative description of the structure of a receiver such as this, with the tines of the RAKE representing the RAKE fingers, and the handle of the RAKE representing the superimposed received signal produced on the output side.

The interference power P_{ISCP,j} in the j-th RAKE finger (related to a chip) is, according to the second exemplary embodiment of the invention, determined using the following relationship:

$${P}_{ISCP , j} = R \cdot ( {\sum }_{k = 1}^{{N}_{Data 2}} {\vert d \cdot {x}_{k , j} - {a}_{j} \cdot {p}_{Data 2 , k} \vert}^{2} + {\sum }_{k = {N}_{Data 2} + 1}^{{N}_{Data 2} + {N}_{Pilot}} {\vert {x}_{k} - {a}_{j} \cdot {p}_{Pilot , k} \vert}^{2} ) \\ R = \frac{1}{{N}_{Data 2} + {N}_{Pilot} - 1} . \qquad ( 4 )$$

In this case, N_{Pilot} once again denotes the number of pilot symbols P_{pilot,k} available in a time slot, and N_{Data2} denotes the number of fed-back, determined data symbols P_{Data2,k}. X_{k,j} denotes the respectively received symbols at the output of the RAKE finger j (that is to say after the synchronization and despreading and before the received signal versions are joined together in the combiner) and d, if necessary, is once again calculated using the equation (3). aⱼ denotes the complex path weightings, as determined by the channel estimation, for each of the reception paths under consideration. In this case:

$${P}_{a} = {\sum }_{j = 1}^{{N}_{Finger}} {\vert {a}_{j} \vert}^{2}$$

The path-specific interference powers P_{ISCP,j} measured in the signal path downstream from the individual RAKE finger j are then combined in accordance with the fundamental combiner rule to form the (total) interference power P_{ISCP} for the channel under consideration:

$${P}_{ISCP} = {\sum }_{j = 1}^{{N}_{Finger}} ( {\vert {a}_{j} \vert}^{2} \cdot {P}_{ISCP , j} ) \qquad ( 5 )$$

The term N_{Finger} denotes the number of active fingers in the RAKE receiver. The channel-related interference power P_{ISCP} is thus obtained from the path-related interference powers P_{ISCP,j} by weighting the path-related interference powers P_{ISCP,j} using the squares of the magnitudes of the complex path weightings determined during the channel estimation, and by subsequently summing over all the active RAKE fingers (that is to say paths).

A further improvement in the interference power determination can be achieved by taking into account interference power measurements in one or more further channels for the calculation of P_{ISCP}. This is due to the fact that PISCP is dependent only on the power P_{RSSI} that arrives at the receiver in all the channels, but is not dependent on the transmission power of the channel under consideration.

P_{RSSI} is highly dependent on the time slot structure and on the power in each transmitted physical channel. When a large number of physical channels are superimposed on one another, the variance of P_{RSSI} becomes smaller, and the mean value of the total signal strength during one time slot represents a good estimation of P_{RSSI}. The lack of any relationship between P_{ISCP} and P_{RSCP} means that it is possible to combine the estimated interference powers P_{ISCP}(n) for different physical channels n:

$${P}_{ISCP} = {\sum }_{n}^{channels} ( {w}_{n} \cdot {P}_{ISCP} ( n ) ) \qquad ( 6 )$$

The variable wₙ in this case denotes a weighting factor, which takes account of the estimation quality in the different channels. That is to say, it depends, for example, on the number of symbols which are used in the individual channels for estimating P_{ISCP}(n).

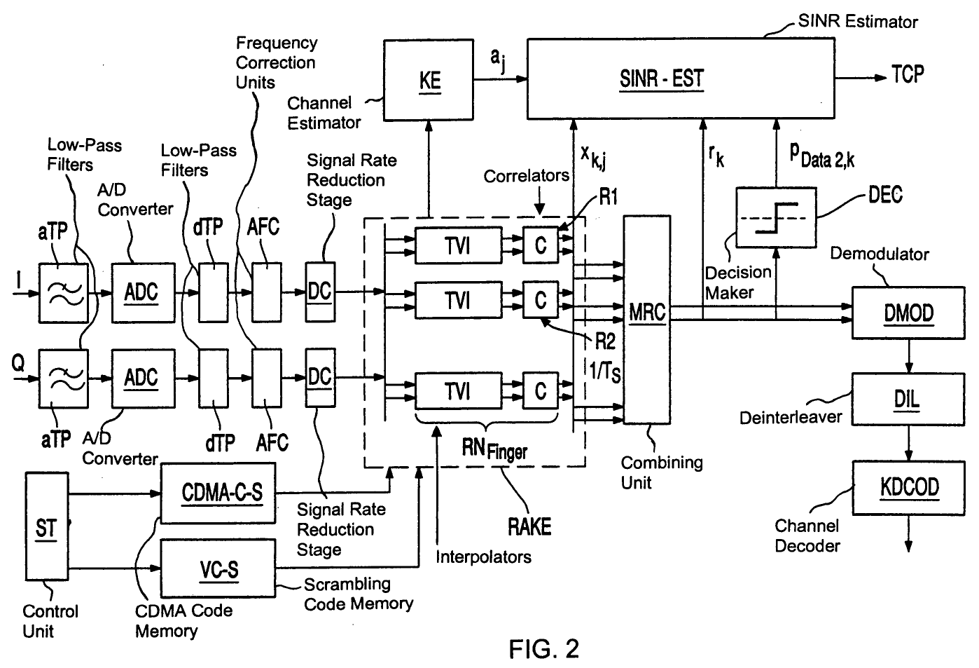

FIG. 2 shows a block diagram of a baseband section of an inventive RAKE receiver.

An analog in-phase (I) signal component and an analog quadrature (Q) signal component of the received data signal are provided at the input of the baseband section.

The analog I and Q signal components each pass through an analog low-pass filter aTP, and are then digitized in analog/digital converters ADC. They are normally digitized with oversampling with respect to the chip rate. The digitized I and Q data signal components are available at the output of the analog/digital converters ADC.

The I and Q digital signals which are emitted from the analog/digital converters ADC are supplied to digital low-pass filters dTP. Frequency correction units AFC may be arranged in each of the signal paths downstream from the digital low-pass filters dTP, and carry out automatic frequency correction of the received digital signals. The frequency correction makes it possible, for example, to compensate for the temperature-dependent frequency drift of the (not illustrated) local oscillator in the reception circuit.

The signal paths downstream from the frequency correction units AFC may include signal rate reduction stages DC, which reduce the signal rate in the I path and Q path.

The I and Q digital signals at the reduced signal rate are supplied to a RAKE receiver section RAKE in the CDMA radio receiver. The RAKE receiver section RAKE is bounded by a dashed line in FIG. 2.

The RAKE receiver section RAKE has N_{Finger} parallel RAKE fingers Rl,R2, . . . ,RN_{Finger}. Each RAKE finger Rl,R2, . . . ,RN_{Finger} in the illustrated example is designed for two channels (for the I and Q paths), as is indicated by double arrows in the signal paths.

On the input side, each RAKE finger Rl,R2, . . . ,RN_{Finger} has a time variant interpolator TVI and, on the output side, it has a correlator C.

The outputs of the RAKE fingers Rl,R2, . . . ,RN_{Finger} are supplied to a maximum rational combining unit MRC, which combines the I/Q outputs to form an overall data signal. An overall RAKE received signal is produced at the output of the MRC unit MRC, and is demodulated in a demodulator DMOD. If interleaving has been carried out at the transmission end, the demodulated overall RAKE received signal is deinterleaved using a deinterleaver DIL. Channel decoding is then carried out in a channel decoder KDCOD.

The CDMA radio receiver also has a CDMA code memory CDMA-C-S and a scrambling code memory VC-S. The CDMA code memory CDMA-C-S can store a number of CDMA codes, and the scrambling code memory VC-S can store a number of scrambling codes. Each scrambling code is an identifier for one specific base station.

A control unit ST can select one specific CDMA code from the CDMA code memory CDMA-C-S and one specific scrambling code from the scrambling code memory VC-S, and can load these into the RAKE receiver section RAKE. The two codes are used in the correlators C for despreading and dechannelization of the signals in the respective RAKE fingers Rl,R2, . . . ,RN_{Finger}. The signals in the RAKE fingers R1,R2, . . . ,RN_{Finger} are first of all synchronized to one another, with chip accuracy, by the time variant interpolators TVI.

In order to determine the interference power PISCP in accordance with the invention, the receiver has an SINR estimator SINR-EST. The SINR estimator SINR-EST is supplied on the one hand with the complex path weightings aⱼ, which have been determined by a channel estimator KE for each path or finger Rl,R2, . . . RN_{Finger} of the RAKE receiver section RAKE. On the other hand, one input of the SINR estimator SINR-EST is connected to one output of a threshold value decision maker DEC. The input of the threshold value decision maker DEC is connected to the output of the MRC unit. The threshold value decision maker DEC carries out a hard decision process to determine a data symbol P_{Data2,k} in the value range, for example, [±1 ±j] from each data value that is emitted by the receiver. These detected data symbols, on which hard decisions have been made, are fed back for the interference power measurement, that is to say they are used to calculate the interference power PISCp in accordance with equation (2) or equation (4). The determination of the interference power PISCP is in this case based on the comparison of the received symbol (either rₖ or X_{k,j}) with the transmitted symbol (pilot symbol or determined data symbol) expected on the basis of the estimated channel.

The signal-to-noise ratio SINR is then calculated using equation 1 in the SINR estimator SINR-EST. The SINR value is used to produce a power control command TCP, which is transmitted to the base station where it is used to control the transmission power.

It should be mentioned that the inventive method can be used universally, that is to say both for the downlink path and for the uplink path.

We claim:

1. A method for determining interference power in a CDMA radio receiver, which comprises:
after obtaining a despread signal by despreading a received signal, determining an interference power of the despread signal by comparing received symbols with symbols that are known a-priori to the receiver and with received data symbols that are not known a-priori to the receiver and determined data symbols that are not known a-priori to the receiver.

2. The method according to claim 1, wherein the step of determining the interference power of the despread signal is performed in a signal path downstream from the receiver.

3. The method according to claim 1, wherein the step of determining the interference power of the despread signal is performed in a signal path downstream from the receiver, and the receiver is a RAKE receiver.

4. The method according to claim 1, wherein:
the receiver is a RAKE receiver having at least two RAKE fingers and a combiner configured downstream from the RAKE fingers; and
the step of determining the interference power of the despread signal includes obtaining measured path interference powers by measuring individual path interference powers of each of the RAKE fingers and calculating the interference power from the measured path interference powers.

5. The method according to claim 1, which comprises:
determining a power of the symbols that are known a-priori and a power of the determined data symbols that are not known a-priori; and
performing the step of determining the interference power of the despread signal by taking into account the power of the symbols that are known a-priori and the power of the determined data symbols that are not known a-priori.

6. The method according to claim 1, wherein the symbols that are known a-priori are pilot symbols and the received data symbols that are not known a-priori to the receiver and the determined data symbols that are not known a-priori are payload data symbols for an individual physical channel.

7. The method according to claim 6, wherein the individual physical channel is a dedicated DPCH channel in accordance with a UMTS Standard.

8. The method according to claim 6, wherein the step of determining the interference power of the despread signal includes using symbols that are known a-priori and/or symbols that are not known a-priori for at least one further physical channel.

9. The method according to claim 8, wherein the further physical channel is a common pilot channel.

10. The method according to claim 1, which comprises using the interference power that has been determined for a channel-specific control of a signal-to-noise ratio on a downlink path.

11. A CDMA radio receiver for receiving a signal of spread-coded symbols that are transmitted via a transmission channel, the CDMA radio receiver comprising:
a unit for proving a despread signal by despreading the signal that has been received;
a channel estimator for determining channel parameters for the transmission channel;
a receiver having an output;
a data symbol decision maker connected to said output of said receiver; and
a device for determining an interference power of the despread signal;
said device for determining the interference power supplied with the channel parameters determined by said channel estimator;
said device for determining the interference power supplied with data symbols determined by said data symbol decision maker;
said device for determining the interference power designed for determining the interference power of the despread signal by comparing received data symbols with symbols that are known a-priori in said receiver and data symbols that are not known a-priori in said receiver; and
said data symbol decision maker determining the data symbols that are not known a-priori in said receiver.

12. The CDMA radio receiver according to claim 11, wherein said device for determining the interference power receives detected symbols.

13. The CDMA radio receiver according to claim 11, wherein:
said receiver is a RAKE receiver that has at least two RAKE fingers with outputs providing received symbols;
said RAKE receiver has a combiner with inputs connected to said outputs of said RAKE fingers; and
said device for determining the interference power receives the received symbols from said outputs of said RAKE fingers.
